(19) United States
(12) Patent Application Publication
(10) Pub. No.: US 2018/0060911 A1
(43) Pub. Date: Mar. 1, 2018

(54) DWELL TIME INCREMENTAL PROMOTIONAL OFFERS

(71) Applicant: International Business Machines Corporation, Armonk, NY (US)

(72) Inventors: Lisa Seacat DeLuca, Baltimore, MD (US); Jeremy A. Greenberger, Raleigh, NC (US)

(21) Appl. No.: 15/246,832

(22) Filed: Aug. 25, 2016

(51) Int. Cl. G06Q 30/02

(52) U.S. Cl. CPC G06Q 30/0261; G06Q 30/0269

(57) ABSTRACT

Disclosed embodiments provide systems and methods for distributing promotional offers based on dwell time. A single program is established that includes multiple steps. Each program step includes an offer, a region, and a dwell time threshold. The region can refer to an area within a retail establishment. The dwell time refers to how long a user is in the given region. The program sends a first offer associated with a first step to a user in response to detecting the user being in the region for a duration that exceeds the first dwell time threshold. If the user continues to dwell in the region, the program sends a second offer associated with a second step to the user in response to detecting the user being in the region for a duration that exceeds the second dwell time threshold.

### FIELD OF THE INVENTION

The present invention relates generally to location tracking and, more particularly, to sending incremental promotional offers to a user device based on dwell time.

### BACKGROUND

Mobile devices such as smart phones and tablets have become commonplace consumer items. Many people carry such a device with them as they shop. These devices have the communication and processing capability to perform location-aware functionality. Modern retail establishments often include multiple departments such as groceries, home goods, shoes, and jewelry, to name a few. This technology allows for an interactive shopping experience in a physical location such as a “brick-and-mortar” retail establishment that provides some features of an online shopping experience. Customers can use their mobile devices such as cell phones, tablet computers, and/or wearable technology as part of a retail shopping experience. As more and more consumers obtain such mobile devices, it is desirable to have improvements in interactive retail shopping experiences.

### SUMMARY

Disclosed embodiments provide systems and methods for distributing promotional offers based on dwell time. A single program is established that includes multiple steps. Each program step includes an offer, a region, and a dwell time threshold. The region can refer to an area within a retail establishment. The dwell time refers to how long a user is in the given region. The program sends a first offer associated with a first step to a user in response to detecting the user being in the region for a duration that exceeds the first dwell time threshold. If the user continues to dwell in the region, the program sends a second offer associated with a second step to the user in response to detecting the user being in the region for a duration that exceeds the second dwell time threshold.

In one aspect, embodiments provide a method for providing offers to a consumer at a physical location, comprising: establishing a single program with a plurality of steps associated with a zone; sending a first offer associated with a first step, of the plurality of steps, to a user in response to detecting the user being in the zone for a duration that exceeds a first dwell time threshold; and sending a second offer associated with a second step, of the plurality of steps, to the user in response to detecting the user being in the zone for a duration that exceeds a second dwell time threshold.

In another aspect, embodiments provide a device comprising: a processor; a memory coupled to the processor; a network interface coupled to the processor; wherein the memory contains instructions, which when executed by the processor, perform the steps of: establishing a single program with a plurality of steps associated with a region; sending a first offer associated with a first step, of the plurality of steps, to a user in response to detecting the user being in the region for a duration that exceeds a first dwell time threshold; and sending a second offer associated with a second step, of the plurality of steps, to the user in response to detecting the user being in the region for a duration that exceeds a second dwell time threshold.

In yet another aspect, embodiments provide a computer program product for providing offers to a consumer at a physical location on an electronic device, comprising a computer readable storage medium having program instructions embodied therewith, the program instructions executable by a processor to cause the electronic device to: establish a single program with a plurality of steps associated with a region; send a first offer associated with a first step, of the plurality of steps, to a user in response to detecting the user being in the region for a duration that exceeds a first dwell time threshold; and send a second offer associated with a second step, of the plurality of steps, to the user in response to detecting the user being in the region for a duration that exceeds a second dwell time threshold.

### BRIEF DESCRIPTION OF THE DRAWINGS

Features of the disclosed embodiments will be more readily understood from the following detailed description of the various aspects of the invention taken in conjunction with the accompanying drawings.

FIG. 1 illustrates a usage of an embodiment of the present invention.

FIG. 2 is a system diagram of an embodiment of the present invention.

FIG. 3 is a block diagram of a device in accordance with embodiments of the present invention.

FIG. 4 shows an exemplary increasing offer sequence in accordance with embodiments of the present invention.

FIG. 5 shows an exemplary decreasing offer sequence in accordance with embodiments of the present invention.

FIG. 6 illustrates a usage of an additional embodiment of the present invention for discontinuous dwell time.

FIG. 7 is a flowchart for embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide systems and methods for distributing promotional offers based on dwell time. A single program is established that includes multiple steps. Each program step includes an offer, a region (zone), and a dwell time threshold. The region can refer to an area within a retail establishment. The dwell time refers to how long a user is in the given region. The user's mobile device may be used in conjunction with an indoor positioning system to track location within a retail premises. The program sends a first offer associated with a first step to a user in response to detecting the user being in the region for a duration that exceeds the first dwell time threshold. If the user continues to dwell in the region, the program sends a second offer associated with a second step to the user in response to detecting the user being in the region for a duration that exceeds the second dwell time threshold.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

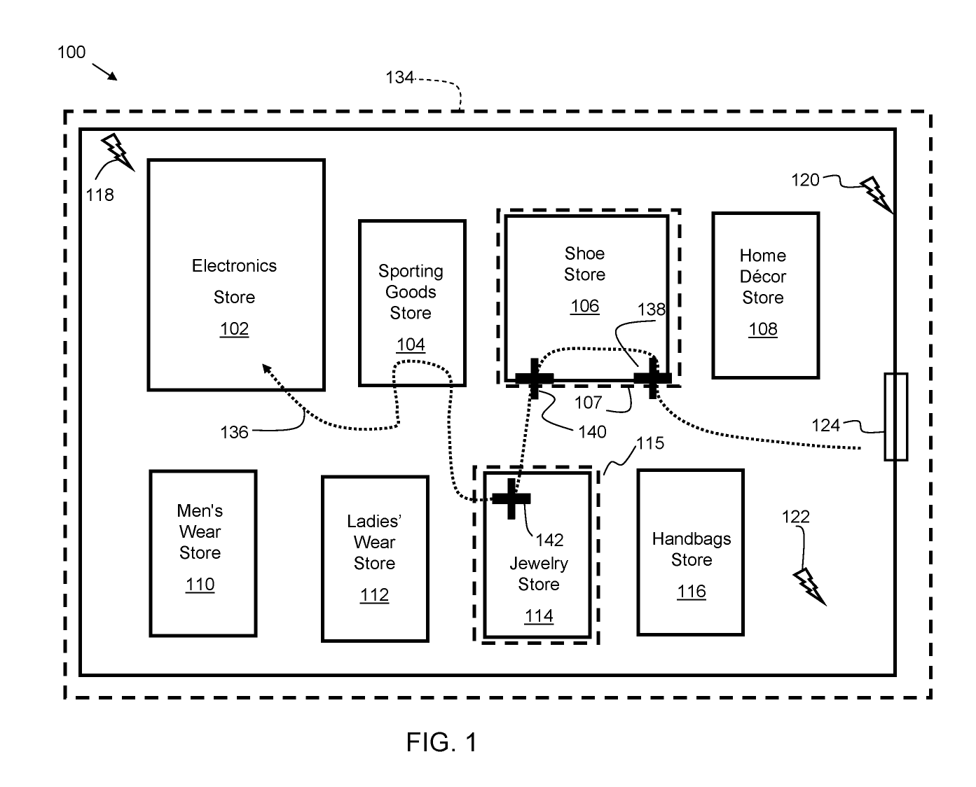

FIG. 1 illustrates a usage of an embodiment of the present invention. In embodiments, a program is associated with a region or zone (a geo-fenced area). In some embodiments, a geo-json object is used for the association. Geo-json is an open standard format designed for representing simple geographical features, along with their non-spatial attributes, based on JavaScript Object Notation. In some embodiments, another suitable mechanism is used for implementing the association. The zone can be any suitable area. For example, the zone may be an indoor area, or an outdoor area, such as a park, parking lot, etc.

In the example of FIG. 1, the area location is a shopping mall 100. The mall 100 has entrance 124. In the mall, there are a number of stores—Electronics Store 102, Sporting Goods Store 104, Shoe Store 106, Home Décor Store 108, Men's Wear Store 110, Ladies' Wear Store 112, Jewelry Store 114, and Handbags Store 116. The location detection system may utilize beacons set up in and/or around the venue. In the example, there are three beacons, 118, 120, and 122. In embodiments, the beacons may be WiFi beacons, Bluetooth® beacons, or any other suitable beacons. Although there are three beacons shown in the example, in implementations, there may be more than three. In some embodiments, one or more geo-fences are established around one or more zones. As the user enters or exits a zone, his/her mobile device interacts with the zone's geo-fence. The program monitors and detects the interaction of the mobile device with the geo-fence in order to calculate dwell time. In the example, zone 134 corresponds to the area of the full venue, while zones 107 and 115 correspond to the outermost walls of the Shoe Store 106 and Jewelry Store 114, respectively. Accordingly, zones 107 and 115 are each a “nested indoor area” since they are located within (i.e. “nested in”) the overall venue 134.

In the example, a user carrying a mobile device, for example, in his/her pocket, enters the mall 100 through entrance 124. The user has previously installed an application for communicating with a remote data server, to the mobile device. In embodiments, the data server executes a single program, in accordance with embodiments of the invention. The single program includes a plurality of steps, where each step has an offer, a zone, and a dwell time. A first offer, associated with a first step of the plurality of steps, is sent to a user device in response to detecting a user has exceeded a first dwell time in a zone. A second offer, associated with a second step of the plurality of steps, is sent to the user device in response to detecting the user has exceeded a second dwell time in the zone.

In the example, the user follows path 136 into shoe store 106. The user's mobile device interacts with geo-fence 107 of shoe store 106 at point 138 as the user enters and at point 140 as the user exits. Once the program detects entry into a region/zone (geo-fenced area), it monitors the amount of time that the user remains within the zone limits. More specifically, the program detects whether the amount of time the user spends exceeds one or more of a series of predetermined dwell time thresholds. In embodiments, an electronic notification is sent to the user's mobile device in response to a determination that the mobile device (inferred to be with the user) has remained within a zone for a duration exceeding a predetermined first dwell time threshold. The sending may include sending of an electronic notification or message from the single program, sending a short message service (SMS) or multimedia messaging services (MMS) message, email, or other method. The electronic notification may include content, such as one or more coupons, special offers, or other suitable content. Another electronic notification with a different offer is sent to the mobile device in response to a determination that the mobile device has remained within the zone for a duration exceeding a predetermined second dwell time threshold.

The single program may develop and use a user profile, including user shopping preferences, to determine and set dwell time thresholds. For example, the single program may detect that the user visited Shoe Store 106 three times in the past thirty days based on the user's mobile phone interactions with geo-fence 107. The single program detected that on the first visit, the user spent 17 minutes, on the second visit, the user spent 15 minutes, and on the third visit, the user spent 13 minutes. The program may calculate the average of those times, or use another suitable formula, to determine the dwell time thresholds at which offers should be sent on the fourth visit. In this example, the single program calculates an average of 10 minutes, and uses that number to calculate three offer dwell time thresholds. The average dwell time for a particular user may be stored in a user profile. In embodiments, the user profile may be stored in the cloud, on a server accessible by the Internet, and/or other networked storage location. For computing the time for each period for which an offer is issued, embodiments may use an example algorithm such as indicated by the following pseudocode:

for (i=1; i≦P;i++)

T(i)=A/P(i)

Where:

A is the average time a user spends in the establishment (geo-fence limits of, e.g., a store).

P is the number of periods.

T(i) is the time for period i.

Thus, considering an example where A is 15 minutes and P is 3, then the times for the periods, using the above algorithm, are computed as:

T(1)=5 minutes

T(2)=10 minutes

T(3)=15 minutes

Thus, after staying in the premises for 5 minutes, the user receives a first offer. After 10 minutes, the user receives a second offer. After 15 minutes, the user receives a third and final offer. In some embodiments, P may be larger than 3 and thus, there can be more than three offers in some embodiments.

Initially, the times at which offers are sent is based on a default setting until the single program learns/calculates the user's average or other “base value”. In some embodiments, the user's shopping preferences are aggregated with other users' preferences, and thresholds are set based on the aggregate numbers. The amount of each offer at the dwell times may be predetermined (for example, 5% at the first dwell time threshold, 10% at the second dwell time threshold, and 15% at the third dwell time threshold).

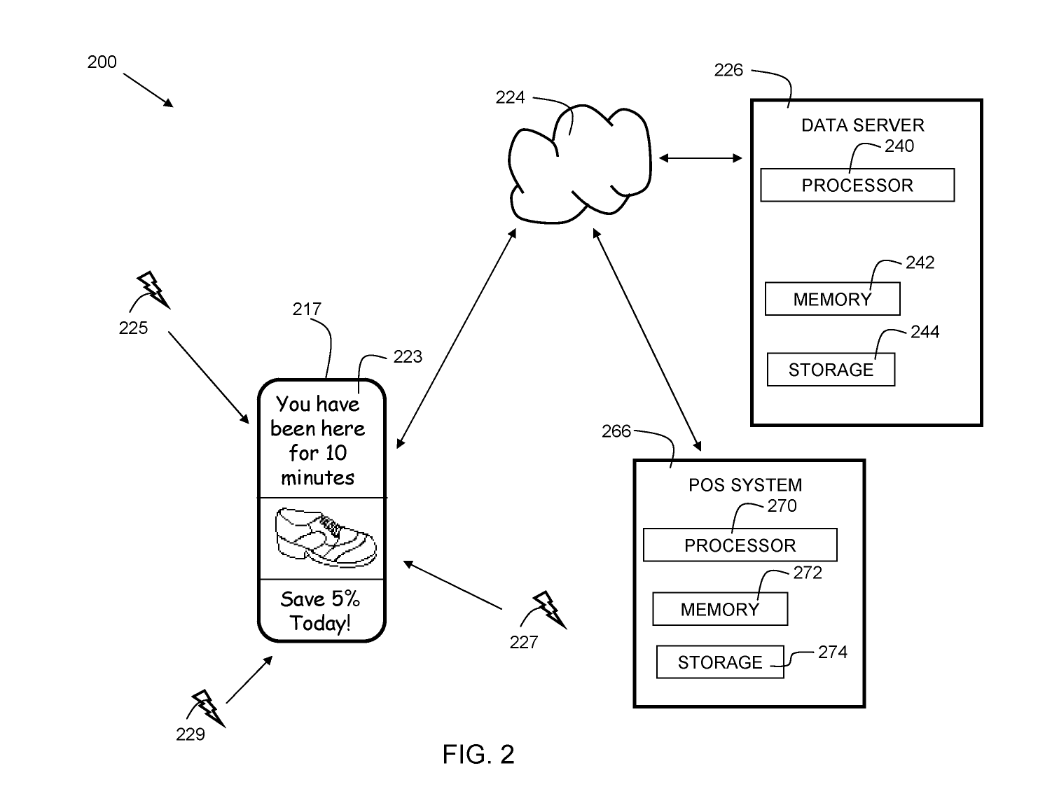

FIG. 2 is a diagram of a system 200 in accordance with an embodiment of the present invention. Mobile device 217, for example, a smartphone, tablet, etc., includes user interface 223. Mobile device 217 is connected via a network 224 to data server 226 and point of sale system 266. In embodiments, the single program is executed on data server 226. Network 224 can be any suitable network, including but not limited to, the Internet, a wide-area network, a local area network, a cloud computing network, etc. Additionally, mobile device 217 may be in communication with three beacons, 225, 227, and 229 for the purpose of location determination. The data server may receive data from the mobile device for processing. Alternatively, or in addition to, the data server may receive processed data from the mobile device for storage. In some embodiments, the device 217 may have zone information stored in memory, and as the device determines its location, it also determines if it has entered/exited a zone, and what action to take. In other embodiments, the device 217 may report its location to the data server 226 via network 224, and the data server 226 may make a determination of if the user has entered/exited a zone. The data server 226 may then send a message to the device 217 instructing the device 217 to present a new offer and/or coupon. Alternatively, the data server may send or have sent an email, SMS, MMS, or other message.

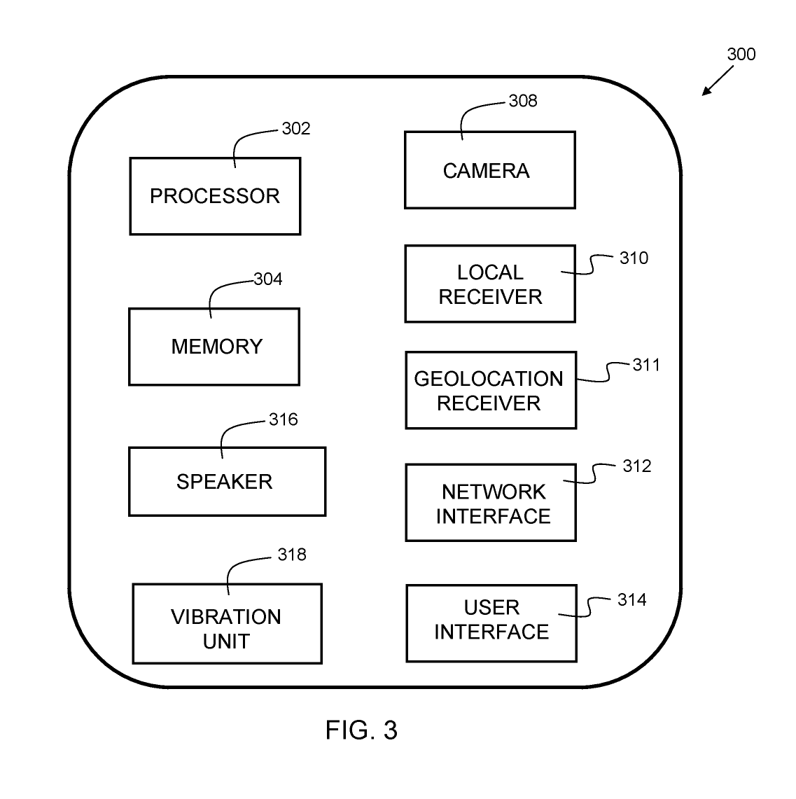

Mobile device 217 has components, explained in detail in FIG. 3. Data server 226 has a processor 240, a memory 242, and storage 244. Point of sale system 266 may be any system that can process the sale of an item or service to the user. For example, without limitation, the point of sale system may be a cash register, or other hardware device or software. POS system 266 has a processor 270, a memory 272, and storage 274. Data server 226 and POS system 266 are each connected to the network 224.

FIG. 3 is a block diagram of a device in accordance with embodiments of the present invention. Device 300 is shown as a simplified diagram of modules. Device 300 includes a processor 302, which is coupled to a memory 304. Memory 304 may include dynamic random access memory (DRAM), static random access memory (SRAM), magnetic storage, and/or a read only memory such as flash, EEPROM, optical storage, or other suitable memory. In some embodiments, the memory 304 may not be a transitory signal per se.

Device 300 further includes a user interface 314, examples of which are a liquid crystal display (LCD), a plasma display, a cathode ray tube (CRT) display, a light emitting diode (LED) display, an organic LED (OLED) display, or other suitable display technology. In some embodiments, user interface 314 may be a touch screen, incorporating a capacitive or resistive touch screen in some embodiments.

The device 300 further includes a network interface 312. The network interface 312 may be a wireless communication interface that includes modulators, demodulators, and antennas for a variety of wireless protocols including, but not limited to, Bluetooth™, Wi-Fi, and/or cellular communication protocols for communication over network 224.

The device 300 may include a local receiver 310 for determining the position of the device. The local receiver 310 includes a receiver for local radio frequency (RF) signals. In embodiments, the local receiver may include a Bluetooth® receiver, ZigBee® receiver, or other near field communication (NFC) receiver.

Mobile device 300 further may include a geolocation receiver 311. The geolocation receiver may be configured to receive signals from multiple satellites to triangulate a position on Earth. In embodiments, the geolocation receiver 311 includes a Global Positioning System (GPS) receiver, GLONASS receiver, Galileo receiver, or other satellite-based positioning system.

In some embodiments, the device 300 may have the form factor of a tablet computer, smart phone, or other mobile device. Accordingly, the device 300 may include a speaker 316, vibration unit 318, and camera 308.

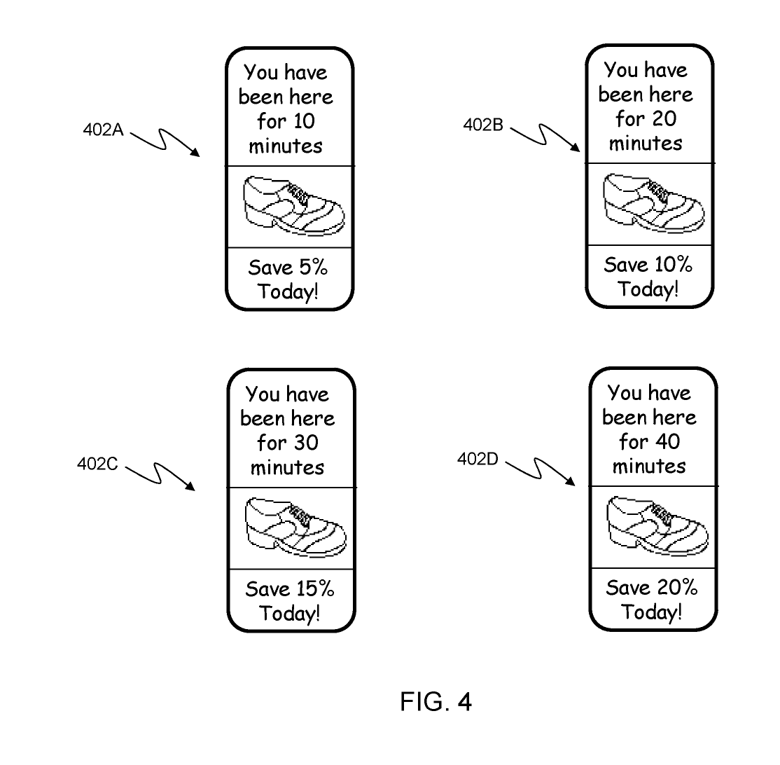

FIG. 4 shows an exemplary increasing offer sequence in accordance with embodiments of the present invention. At 402A-402D, there are shown mobile device user interfaces displaying content sent, by the single program, in response to detection of a sequence of various dwell time thresholds being exceeded in a zone. In the example shown, the amount of discount increases as the dwell time in the zone increases. This incentivizes shoppers to stay in the store. A first offer, sent in response to detection of the exceeding of a first dwell time threshold in a zone, comprises a first discount. A second offer, sent in response to detection of the exceeding of a second dwell time threshold in the zone, comprises a second discount. The second discount is larger than the first discount. A third discount, sent in response to the exceeding of a third dwell time threshold in the zone, is larger than the second discount, and so on. The single program can include a formula for determining discount. For example, the formula: D=K*P, where K is a constant and P is the ordinal dwell period, so in period one, if K=5, the discount D is 5%, in period 2 the discount is 10%, etc. This is an exemplary formula—others may be substituted. Note that the discount can instead be in terms other than percentages, such as specific dollar amounts.

As depicted at 402A, there is shown a first offer of 5% off in response to detection of the user spending a duration of time within the geo-fenced zone exceeding a first dwell time threshold of 10 minutes. At 402B, a second offer of 10% off is sent and displayed on user's mobile device interface in response to detection of the user spending a duration of time within the zone exceeding the second dwell time threshold of 20 minutes. At 402C, yet another offer of 15% off is sent and displayed on the user's mobile device interface in response to detection of the user spending a duration of time exceeding a third dwell time threshold within the zone of 30 minutes. In some embodiments, the single program establishes a maximum offer limit. In the example, the maximum offer limit is 20% off. At 402D, the user reaches this maximum limit by spending at least 40 minutes (fourth threshold) in the geo-fenced zone. The final offer of 20% off is sent to the user's mobile device, and further offers are not sent in response to any further detected extra dwell time.

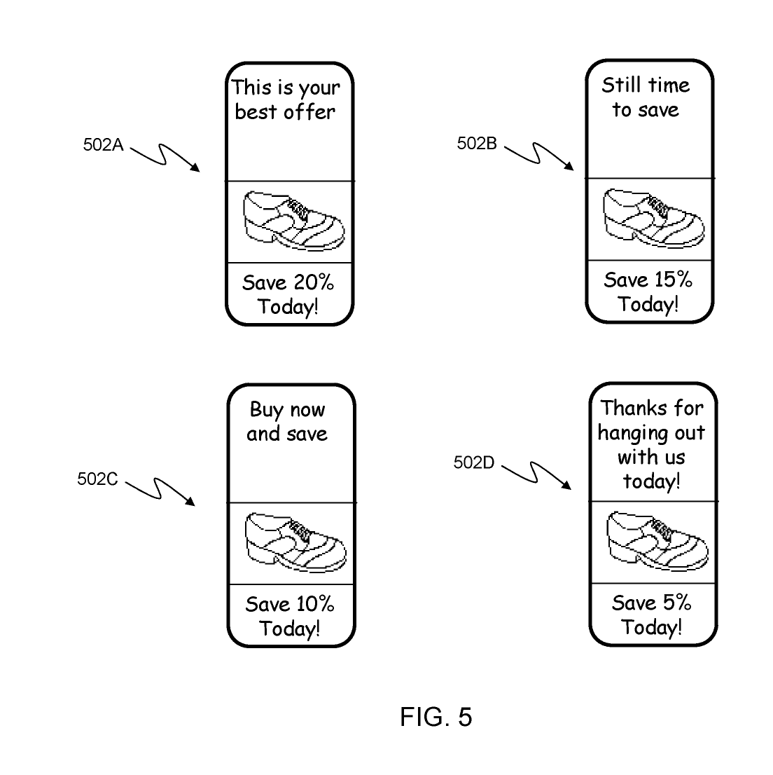

FIG. 5 shows an exemplary increasing offer sequence in accordance with embodiments of the present invention. At 502A-502D, there are shown mobile device user interfaces displaying content sent, by the single program, in response to detection of a sequence of various dwell time thresholds being exceeded. In the example shown, the amount of discount decreases as the dwell time in the zone increases. This incentivizes shoppers to “buy now” (i.e., make the purchase quickly). A first offer, sent in response to detection of the exceeding of a first dwell time threshold in a zone, comprises a first discount. A second offer, sent in response to detection of the exceeding of a second dwell time threshold in the zone, comprises a second discount. The second discount is smaller than the first discount. A third offer, sent in response to the exceeding of a third dwell time threshold in the zone, is yet smaller than the second discount, and so on.

As depicted at 502A, there is shown a first offer of 20% off in response to detection of the user spending a duration of time within the geo-fenced zone exceeding a first dwell time threshold. At 502B, a second offer of 15% off is sent and displayed on user's mobile device interface in response to detection of the user spending a duration of time within the zone exceeding the second dwell time threshold. At 502C, yet another offer of 10% off is sent and displayed on the user's mobile device interface in response to detection of the user spending a duration of time exceeding a third dwell time threshold within the zone. In some embodiments, the single program establishes a maximum offer limit. In the example, the final offer is the minimum offer limit of 5% off. At 502D, the user reaches this minimum limit by exceeding a fourth dwell time threshold in the geo-fenced zone. The final offer of 5% off is sent to the user's mobile device, and further offers are not sent in response to any further detected additional dwell time. Thus, in these embodiments, the best offer is presented first, and subsequent offers are not as good for the consumer, intended to encourage purchasing quickly upon entering the store. These embodiments can be used to help reduce crowds during busy shopping periods such as holiday seasonal shopping.

In some embodiments, the threshold amount of time corresponding to a first dwell time and a second dwell time are determined based on an average amount of time the particular user, or a plurality of users, spends in a particular store or type of store. For example, the single program calculates that in the last 30 days, a user spent an average of 20 minutes in a shoe store based on four total visits. Alternatively, the single program calculates that an average time spent in the shoe store by a plurality of users is 20 minutes. Based on the calculated average, a plurality of dwell time thresholds are determined. In the example, the thresholds are calculated according to the following algorithm. A first dwell time threshold is set to 0.5 of the average, a second dwell time threshold is set to 1.0 of the average (i.e., equal to the average), and a third dwell time threshold is set to 1.5 of the average. Accordingly, a first offer is sent to the user's mobile device after 10 minutes is exceeded by the user in the shoe store. A second offer is sent after 20 minutes is exceeded, and a third offer is sent after a third threshold of 30 minutes (1.5×20) is exceeded by the user in the shoe store.

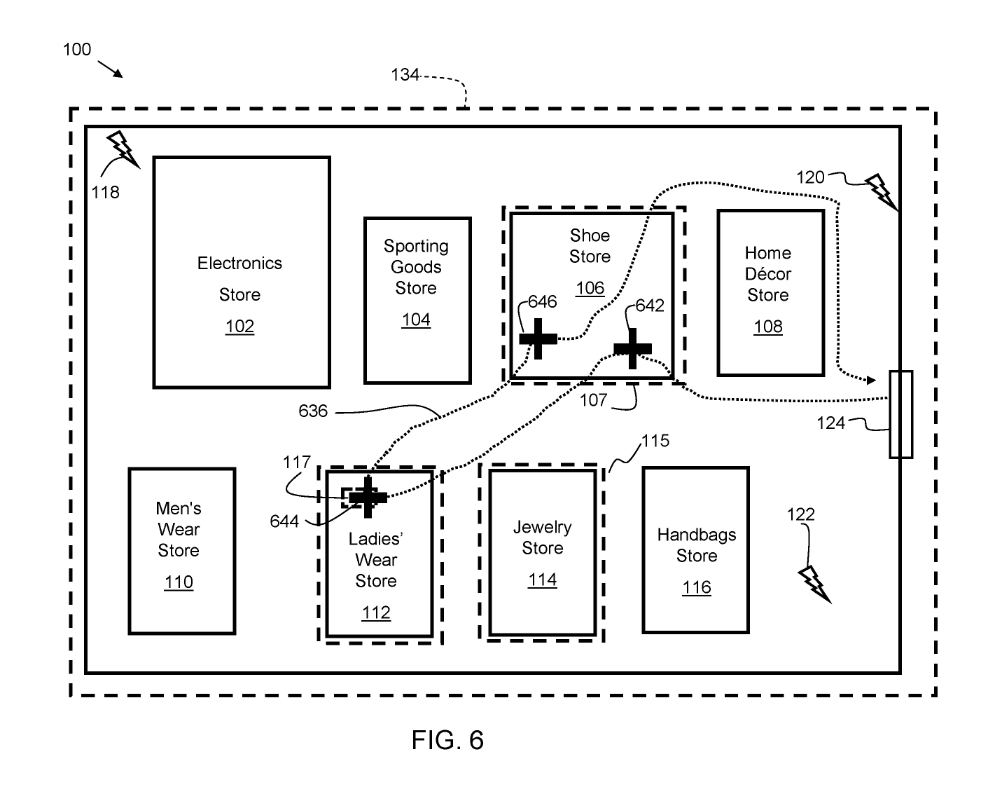

FIG. 6 illustrates a usage of an additional embodiment of the present invention for discontinuous dwell. In some embodiments, a user's dwell time is aggregated over multiple visits to the geo-fenced area. Therefore, the dwell time includes a discontinuity. The amount of discontinuity allowed prior to a reset is predetermined. For example, the amount may be 2 hours, or the amount may be 30 days, before a reset. In the embodiment, the user, carrying his/her mobile device on his/her person, enters the mall through entrance 124, and follows path 636. On such path, the user enters Shoe Store 106 and spends 11 minutes within the store around point 642. The user then exits and walks to the Ladies Wear Store 112 and spends 6 minutes around point 644. The user then exits the Ladies wear Store 112 and walks back to the Shoe Store 106, and spends 14 minutes around point 646. Finally, the user then exits the mall through entrance 124. The user's dwell time at Shoe Store 106 within geo-fence 107 is computed including both the first and second visits (i.e., sessions). A first offer is sent to the user's mobile device at 10 minutes while the user is still in Shoe Store 106. A second offer is then sent to the user's mobile device upon his/her return at 9 minutes into the 14 minutes since the total of each time from the two visits to Shoe Store 106 at that time is 20 minutes. Thus, in this example, the session user dwell time is 20 minutes, and the session user dwell time includes a discontinuity (since the 20 minutes was accrued over two visits to the premises).

Still referring to FIG. 6, in some embodiments, the single program pauses based on detection of a user near a checkout point of sale (POS) system. Detection of a user near a POS system exceeding a predetermined amount of time may indicate that the user is ready to check out. Accordingly, no further incentive is needed to induce the user to make a purchase. Embodiments may set a predetermined time threshold for dwell time in a checkout region ((i.e., within 10 feet of POS system/cash register for more than, for example, 5 minutes). If such conditions are met, it is inferred that the user is waiting in the checkout line. For example, a user walks around Ladies' Wear Store 112 for 12 minutes. After a first threshold of 10 minutes is exceeded, a first offer is sent to the user's mobile device. The user then walks to point 644, which is within geo-fence 117 that defines a perimeter of 10 feet in each direction around a checkout area (POS system). After the user dwells there for 5 minutes, it is inferred that he/she is checking out, so no further offers are sent as dwell time increases even though the second predetermined threshold (e.g., 20 minutes total) may be exceeded while the user waits or checks out. Thus, in embodiments, the single program is paused upon detecting the user in a checkout area. If the user steps out of line, and walks out of the geo-fence, or more than the predetermined distance from POS area 117 (for example, 5 feet from the geo-fence 117), the system may send offers again based on total dwell time since it is inferred that either the user was not actually in line, or the user changed his/her mind about making the purchase.

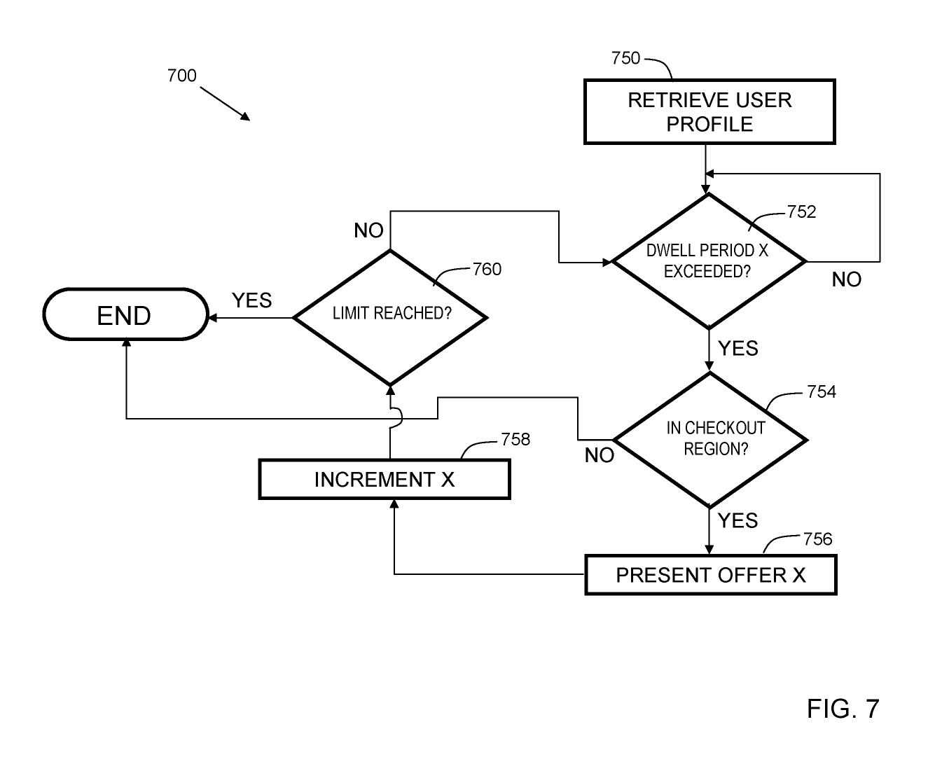

FIG. 7 is a flowchart 700 for embodiments of the present invention. At 750, a user profile is retrieved. The user profile may contain average dwell times for a user at various establishments. If no average dwell time is available, a system-wide default may be used (e.g., 20 minutes). At 752, it is determined whether predetermined dwell period X is exceeded. If no, the process continues at 752 until such time as the dwell period X time is exceeded. If yes, the process continues to step 754, where it is determined whether the user is in the checkout region. If no, the process ends. If yes, offer corresponding to X is presented at step 756. At 758, the calculated dwell time is incremented by X. The process then continues to step 760 where it is determined whether a time limit is reached. If yes, the process ends. If no, the process continues to step 752 for determination whether then next dwell time has been exceeded.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A method for providing offers to a consumer at a physical location, comprising:
establishing a single program with a plurality of steps associated with a zone;
sending a first offer associated with a first step, of the plurality of steps, to a user in response to detecting the user being in the zone for a duration that exceeds a first dwell time threshold; and
sending a second offer associated with a second step, of the plurality of steps, to the user in response to detecting the user being in the zone for a duration that exceeds a second dwell time threshold.

2. The method of claim 1, wherein the first offer comprises a first discount, and wherein the second offer comprises a second discount, and wherein the second discount is larger than the first discount.

3. The method of claim 1, wherein the first offer comprises a first discount, and wherein the second offer comprises a second discount, and wherein the second discount is smaller than the first discount.

4. The method of claim 1, wherein the first dwell time threshold and the second dwell time threshold are based on an average dwell time of the user.

5. The method of claim 1, further comprising computing a session user dwell time, wherein the session user dwell time includes a discontinuity.

6. The method of claim 1, further comprising establishing a maximum offer limit.

7. The method of claim 1, further comprising establishing a minimum offer limit.

8. The method of claim 1, wherein the single program is paused upon detecting the user in a checkout area.

9. The method of claim 1, wherein the single program comprises a formula computing an offer as a function of dwell time.

10. A device comprising:
a processor;
a memory coupled to the processor;
a network interface coupled to the processor;
wherein the memory contains instructions, which when executed by the processor, perform the steps of:
establishing a single program with a plurality of steps associated with a region;
sending a first offer associated with a first step, of the plurality of steps, to a user in response to detecting the user being in the region for a duration that exceeds a first dwell time threshold; and
sending a second offer associated with a second step, of the plurality of steps, to the user in response to detecting the user being in the region for a duration that exceeds a second dwell time threshold.

11. The device of claim 10, wherein the first offer comprises a first discount, and wherein the second offer comprises a second discount, and wherein the second discount is larger than the first discount.

12. The device of claim 10, wherein the first offer comprises a first discount, and wherein the second offer comprises a second discount, and wherein the second discount is smaller than the first discount.

13. The device of claim 10, wherein the first dwell time threshold and the second dwell time threshold are based on an average dwell time of a user.

14. The device of claim 10, wherein the memory further contains instructions, which when executed by the processor, perform the step of computing a session user dwell time, wherein the session user dwell time includes a discontinuity.

15. The device of claim 10, wherein the memory further contains instructions, which when executed by the processor, perform the step of comprising establishing a maximum offer limit.

16. The device of claim 10, wherein the memory further contains instructions, which when executed by the processor, perform the step of comprising establishing a minimum offer limit.

17. The device of claim 10, wherein the memory further contains instructions, which when executed by the processor, perform the step of pausing the single program upon detecting the user in a checkout area.

18. A computer program product for providing offers to a consumer at a physical location on an electronic device, comprising a computer readable storage medium having program instructions embodied therewith, the program instructions executable by a processor to cause the electronic device to:
establish a single program with a plurality of steps associated with a region;
send a first offer associated with a first step, of the plurality of steps, to a user in response to detecting the user being in the region for a duration that exceeds a first dwell time threshold; and
send a second offer associated with a second step, of the plurality of steps, to the user in response to detecting the user being in the region for a duration that exceeds a second dwell time threshold.

19. The computer program product of claim 18, further comprising program instructions executable by the processor to cause the electronic device to perform the step of computing a session user dwell time, wherein the session user dwell time includes a discontinuity.

20. The computer program product of claim 18, further comprising program instructions executable by the processor to cause the electronic device to compute the first dwell time threshold and the second dwell time threshold based on an average dwell time of the user.
